(19) United States
(12) Patent Application Publication
(10) Pub. No.: US 2002/0031200 A1
(43) Pub. Date: Mar. 14, 2002

(54) Method for controlling boiling water reactor vessel chemistry

(76) Inventor: H. Michael Metell, Keene, NH (US)

Correspondence Address: Schmeiser, Olsen & Watts LLP, 18 East University Drive, #101, Mesa, AZ, 85201, US

(21) Appl. No.: 09/844,163

(22) Filed: Apr. 27, 2001

Related U.S. Application Data
(63) Continuation-in-part of application No. 09/267,545, filed on Mar. 12, 1999, now abandoned.

(51) Int. Cl. G21C 15/00; G21C 19/28

(52) U.S. Cl. 376/370

(57) ABSTRACT

A method for controlling vessel chemistry in a boiling water reactor (BWR) includes a targeted injection of hydrazine (N₂H₄) to overcome intergranular stress corrosion cracking (IGSCC) and provide other advantages. The method does not require the injection of hydrogen as a reducing species nor the costly equipment needed to store and control the injection of hydrogen, but it is optional. The method involves: 1) adding a carefully selected amount of N₂H₄ at a carefully selected location such that reaction with hydrogen peroxide (H₂O₂) is targeted for reduction prior to treated vessel water (feed water combined with steam dryer/separator liquid effluent) entering the reactor core and 2) providing sufficient residence time to keep all but a tolerable amount of the N₂H₄ from entering the reactor core. The method may also include the steps of: 1) examining vessel water upstream of the reactor core to assess the type and amount of N₂H₄ fragments and 2) calculating and/or externally measuring electrochemical corrosion potential (ECP) from the type and amount of N₂H₄ fragments. That is, the injection of N₂H₄ may be used to control in-vessel chemistry, but can also be used as a tool to monitor vessel chemistry and determine vessel ECP.

### BACKGROUND OF THE INVENTION

1. Technical Field

This invention relates to the field of boiling water reactors. More specifically, the invention relates to a method for controlling boiling water reactor vessel chemistry.

2. Background Art

The current world population has developed a high level of dependence on electric power and a variety of systems are available for generating the vast amounts of electric power currently required. Nuclear reactors are one well known system for generating electric power. In one type of nuclear reactor, a boiling water reactor (BWR), vessel water is heated in a reactor core where nuclear fission occurs and the resulting steam is used to turn turbines for electric power generation. To avoid damage to the turbines, steam generated from the reactor core is dried inside the BWR vessel in a steam separator and steam dryer and the collected water (liquid effluent) is returned for reheating to the reactor core without leaving the BWR vessel. The dried steam sent to the turbines ultimately condenses and is returned as feed water to the BWR vessel where it is combined with the steam dryer/separator liquid effluent to form vessel water that is subsequently reheated in the reactor core.

The materials used in a BWR are carefully selected to withstand, as much as possible, the conditions within the BWR vessel. Nevertheless, intergranular stress corrosion cracking (IGSCC) is a known phenomenon that occurs in the various components of a BWR. The causes and effects of IGSCC are well documented in numerous technical and patent references. Prior attempts to remedy IGSCC are disclosed in the following U.S. patents that are herein incorporated by reference: U.S. Pat. Nos. 5,135,709, 5,608,766 and 5,581,588 issued to Andresen et al., U.S. Pat. No. 4,430,293 issued to Callaghan et al., U.S. Pat. No. 4,842,811 issued to Desilva, U.S. Pat. Nos. 5,473,646 and 5,301,271 issued to Heck et al., U.S. Pat. No. 5,287,392 issued to Cowan II, et al., U.S. Pat. No. 5,130,079 issued to Chakraborty, U.S. Pat. No. 5,164,152 issued to Kim et al., U.S. Pat. Nos. 5,130,081 and 5,130,080 issued to Niedrach, U.S. Pat. Nos. 5,602,888, 5,600,692, 5,600,691, and 5,448,605 issued to Hettiarachchi et al.

As discussed in the above listed references and in a wide variety of other references, the primary causative agent focused on in IGSCC studies is oxygen produced from the radiolytic decomposition of water when subjected to irradiation in the reactor core. The presence of the excess dissolved oxygen in the heated water creates an electrochemical corrosion potential (ECP) which will result in increasing IGSCC attack as the ECP increases (e.g. becomes more positive). While other oxidizing species, such as hydrogen peroxide are produced from radiolytic decomposition of water, very strong emphasis has been placed on providing reducing species to combine specifically with oxygen and thus reduce the ECP. While attempts have been made at using ammonia and hydrazine as reducing species in a test reactor core, serious disadvantages of these reducing species became readily apparent. Accordingly, hydrogen is universally accepted as the reducing species of choice in a BWR. The hydrogen is generally injected into feed water which then enters the BWR vessel. By providing an excess amount of hydrogen in the vessel water of a BWR, the equilibrium of the hydrogen-oxygen recombination reaction is shifted to encourage conversion of oxygen as an oxidizing species to water.

Unfortunately, there are several widely recognized disadvantages of using hydrogen as a reducing agent, even though hydrogen is the most preferred reducing agent. First, a relatively large amount of gaseous hydrogen must be maintained near the BWR creating a potential industrial hazard since hydrogen is highly flammable. Second, hydrogen gas must be added continuously in small amounts that are potentially difficult to control in transient operation. The amount of hydrogen directly affects the radiation dose in steam lines supplying steam to the turbines from the carryover of radioactive nitrogen 16 (N¹⁶) in the form of ammonia that is generated in the reactor core. Variations in the flow of feed water and/or hydrogen addition may cause spikes in the concentration of hydrogen and resulting spikes in radiation dose in steam lines or large variations in ECP. Third, although known as an oxygen scavenger, hydrogen recombination with oxygen is typically considered “sluggish” in BWR reactor environments. The inefficiency of the recombination reaction encourages injection of more hydrogen than is theoretically needed. This excess hydrogen tends to form volatile ammonia with highly radioactive N¹⁶ in the reactor core, and causes increased steam line dose rates when the N¹⁶ ammonia exits the reactor. Fourth, the only presently available hydrogen injection system is very costly.

Given the problems associated with hydrogen as a reducing species, various catalytic processes have been proposed for use in a BWR to enhance the hydrogen- oxygen recombination reaction. While several systems are described in the above referenced patents, perhaps the most promising to date involves treating the BWR vessel and vessel components with a chemical catalyst including platinum and rhodium in a soluble liquid form. The catalyst is applied when the reactor is about to shut down for fuel reloading and is predicted to last through the next fuel cycle. By mechanically bonding to the vessel and vessel components, the catalyst promotes recombination of oxygen with hydrogen rather than combination of oxygen with iron or other elements in stainless steel components that causes corrosion. Using the catalyst along with hydrogen injection, as described above, reduces the amount of hydrogen needed and produces fewer side effects than hydrogen injection alone. Nevertheless, the cost of the catalyst is extremely high as is the instrumentation used to monitor the effectiveness of the catalyst system.

Thus, it can be seen that there exists a need to provide a method for controlling IGSCC that reduces the hazards, costs, and instabilities of present methods, such as hydrogen injection and/or catalytic recombination. Without such improved methods, electric utilities operating nuclear reactors will continue to face the current unfavorable and costly circumstances involved in controlling IGSCC.

### DISCLOSURE OF INVENTION

According to the present invention, a method for controlling vessel chemistry of a boiling water reactor (BWR) is provided that does not require the injection of hydrogen as a reducing species nor the costly equipment needed to store and control the injection of hydrogen. The method includes the steps of: 1) adding hydrazine (N₂H₄) to react with hydrogen peroxide (H₂O₂) in a BWR and to reduce the amount of H₂O₂ to a desired amount in vessel water that enters the reactor core and 2) providing a sufficient residence time to consume all but a tolerable amount of the added N₂H₄ prior to the vessel water entering the reactor core.

By way of example, the method may further include the steps of: 1) determining the amount of H₂O₂ in steam dryer/separator liquid effluent and 2) selecting the amount of N₂H₄ at least partially based upon the determined amount of H₂O₂ in the liquid effluent. If the H₂O₂ can be reduced to less than approximately 5 part per billion (ppb) (mass) in vessel water entering the reactor core, several advantages are obtained. First, the environment causing intergranular stress corrosion cracking (IGSCC) is made less oxidizing and more reducing, thus protecting (in part or in full) components downstream where H₂O₂ is reduced. If accomplished rapidly, much less ammonia containing N¹″ (radioactive nitrogen) is produced in the reactor core compared to when hydrogen is used as a reducing species. Further, while N₂H₄ is relatively costly to purchase, the equipment needed for handling and injecting N₂H₄ into the BWR is conventional industrial equipment that is much less costly than hydrogen injection equipment. Additionally, by reducing the amount of H₂O₂, samples of vessel water entering the reactor core may be collected and analyzed by conventional testing without concern for misrepresentation of water chemistry from decomposition of unstable H₂O₂ species in the collected sample. Without such capability, very costly in-vessel probes and associated analyzing equipment would be required to accurately represent water chemistry of the vessel water entering the reactor core.

Several control scenarios are conceivable when using the present method. For example, first, the amounts of N₂H₄ selected for injection may be targeted to only partially reduce the amount of H₂O₂ in vessel water. Second, the amount of N₂H₄ selected may be sufficient to reduce H₂O₂ to less than approximately 5 ppb, without affecting the presence of oxygen (O₂). Third, the amount of N₂H₄ added may be sufficient to reduce H₂O₂ to below approximately 5 ppb and also affect the amount of O₂ present by reducing it as much as possible while still consuming all but a tolerable amount of the added N₂H₄ prior to vessel water entering the reactor core. Fourth, since some BWRs may be less sensitive to the byproducts produced when N₂H₄ decomposes in the reactor core, consuming all but a tolerable amount of the added N₂H₄ may leave behind a relatively large amount of N₂H₄ when compared to the amount of N₂H₄ that may be tolerated in another BWR system. For most BWR systems, consuming all but a tolerable amount requires consuming substantially all of the N₂H₄, for example, approximately 5 ppb or less.

The effectiveness of the N₂H₄ injection can be modified depending upon the location of the injection. One example of a preferred location is injecting N₂H₄ in the feed water line upstream of feed water spargers such that N₂H₄ laden feed water is applied to returned steam dryer/separator liquid effluent in the BWR mixing plenum. Also, reaction of N₂H₄ with H₂O₂ may be enhanced by providing a catalyst. For example, ionic copper (Cu²⁺ ) acts as a catalyst for this reaction and may be present in the feed water of some BWR systems. Further, the method described above may also be used in conjunction with a noble metal catalyst promoting combination of hydrogen and oxygen and/or additionally injecting excess hydrogen to promote such recombination. Accordingly, while N₂H₄ injection may be used alone to control vessel chemistry of a BWR, it is compatible with the simultaneous use of conventional methods for controlling vessel chemistry and may be used in combination therewith.

Finally, the present method may also include the steps of: 1) examining vessel water upstream of the reactor core to assess the type and amount of N₂H₄ fragments and 2) calculating and/or externally measuring electrochemical corrosion potential (ECP) from the type and amount of N₂H₄ fragments (nitrogen, ammonium hydroxide, and unreacted hydrazine, where ammonium hydroxide is the water soluble form of ammonia). That is, the injection of N₂H₄ may be used to control in-vessel chemistry, but can also be used as a tool to monitor vessel chemistry and determine vessel ECP. Such a method thus enables a straight forward mechanism for ensuring that proper protection of the vessel and vessel components is provided.

The foregoing and other features and advantages of the present invention will be apparent from the following more particular description of preferred embodiments of the invention, as illustrated in the accompanying drawings.

### BRIEF DESCRIPTION OF DRAWINGS

Preferred embodiments of the present invention will hereinafter be described in conjunction with the appended drawings, where like designations denote like elements, and:

FIG. 1 is a flow diagram of a method according to a preferred embodiment of the present invention;

FIG. 2 is a flow diagram of boiling water reactor system according to a preferred embodiment of the present invention;

FIG. 3 is a more detailed flow diagram of the reactor vessel in FIG. 2; and

FIG. 4 is a chart of electrochemical corrosion potential as a function of hydrazine injection concentration.

### BEST MODE FOR CARRYING OUT THE INVENTION

According to a preferred embodiment of the present invention, a method for controlling vessel chemistry in a boiling water reactor (BWR) is provided that uses a targeted injection of hydrazine (N₂H₄) to overcome the various problems with conventional methods for reducing intergranular stress corrosion cracking (IGSCC) and providing other new advantages. In particular, the method reduces electrochemical corrosion potential (ECP) in a BWR. The method does not require the injection of hydrogen as a reducing species nor the costly equipment needed to store and control the injection of hydrogen, but it is optional. The method involves: 1) adding a carefully selected amount of N₂H₄ at a carefully selected location such that reaction with hydrogen peroxide (H₂O₂) is targeted for reduction prior to treated vessel water (feed water combined with steam dryer/separator liquid effluent) entering the reactor core and 2) providing sufficient residence time to keep all but a tolerable amount of the N₂H₄ from entering the reactor core. The targeted reaction is N₂H₄+2H₂O₂→N₂+4H₂O. While N₂H₄ is known as a reducing species for nuclear reactor feed water and H₂O₂ is known as an oxidizing species, it is not known to select the amount of N₂H₄ added and the injection location such that reaction with H₂O₂ is targeted. N₂H₄ has been traditionally assumed to be ineffective in a BWR because of its break up from radiation in the reactor core and its ineffectiveness as demonstrated in published test results. (“Development and Use of an In-Pile Loop for BWR Chemistry Studies,” MIT Nuclear Reactor Laboratory, Electric Power Research Institute, September 1993, pgs. 6-1 to 6-15.) However, it has been discovered that significant advantages can be obtained by shifting the focus of controlling vessel chemistry to reducing H₂O₂ prior to vessel water entering the reactor core and keeping N₂H₄ out of the reactor core.

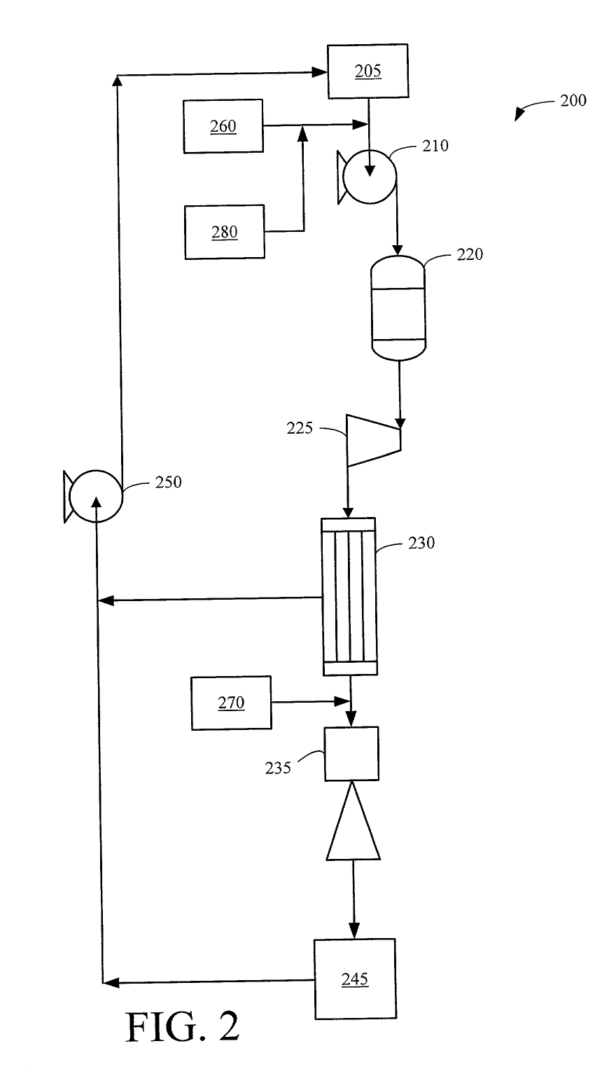

Turning to the figures, FIG. 2 shows a BWR system 200 including hydrazine injection according to a preferred embodiment of the present invention. In BWR system 200, feed water is provided to a feed water inlet 205 connected to feed water pumps 210 that supply feed water to reactor vessel 220, preferably through feed water heaters (not shown). Steam is produced from the feed water in reactor vessel 220 and supplied to a turbine 225 for production of electricity. After the steam flows through turbine 225, it is supplied to a condenser 230 where the steam is condensed to form condensate that is sent to condensate pumps 250, and preferably through feed water heaters (not shown), in preparation for returning condensate to feed water pump inlet 205. As is generally known and taught in the patents incorporated herein by reference, the steam produced from reactor vessel 220 contains a variety of gaseous substances in addition to steam. For example, the steam contains a substantial portion of hydrogen gas (H₂) and oxygen gas (O₂) and a small portion of radioactive gas that pass through condenser 230 and require removal. Accordingly, a steam jet air ejector 235 is provided for transporting these gases to an Advanced Off Gas (AOG) system 245 for further processing. AOG System 245 recombines the hydrogen and oxygen gases back into water (condensate) and sends the condensate to condensate pumps 250. AOG System 245 also renders the radioactive gases harmless.

When BWR system 200 is operated without H₂ injection, typically the steam exiting reactor vessel 220 contains a stoichiometric mixture of H₂ and O₂ since their source is the radiolytic decomposition of water. That is, water contains two hydrogen atoms for every one oxygen atom. Assuming H₂ and O₂ are the only decomposition products, two moles of H₂ will exist in the steam for every one mole of O₂. In reality, other decomposition products exist, but H₂ and O₂ are the primary products so at least an approximately stoichiometric mixture of H₂ and O₂ is provided in steam exiting reactor vessel 220. Nevertheless, condenser 230 typically suffers some air in-leakage and thus creates a more oxygen rich gas stream supplied to SJAE 235. The air in-leakage also enriches the steam from reactor vessel 220 with nitrogen since air is primarily composed from oxygen and nitrogen. Accordingly, AOG System 245 also separates nitrogen and excess oxygen from the reactor steam.

When hydrogen injection is used to control IGSCC, excess hydrogen is typically injected to react with oxygen within reactor vessel 220. This creates an excess of hydrogen above the stoichiometric mix in reactor vessel 220 and in steam leaving reactor vessel 220. Excess hydrogen presents a detonation hazard. Also, one purpose of AOG System 245 is to form water (H₂O) from H₂ and O₂. Thus, compensating oxygen must provided so that the H₂ and O₂ mixture becomes near stoichiometric and may be safely recombined into condensate in AOG System 245. FIG. 2 shows an oxygen injection system 270 that may be necessary to adjust the relative composition of hydrogen and oxygen by adding oxygen. Depending on the particular mechanisms used in AOG System 245, a desired relative composition for hydrogen and oxygen may be selected and controlled with oxygen injection system 270.

For the present invention, it is predicted that the strategic addition of hydrazine into BWR system 200 will more effectively react with H₂O₂, creating less excess hydrogen in reactor vessel 220 and turbine 225 discharge gases. Thus, BWR System 200 according to a preferred embodiment of the present invention may require less air in-leakage or oxygen injection than conventional systems. Further, it is possible that oxygen addition by oxygen injection system 270 will not be required for BWR System 200. However, oxygen injection system 270 can be maintained to be conservative and, if needed, may utilize air addition (instead of pure oxygen addition) depending on the capabilities of AOG System 245 to handle non-condensable gases such as nitrogen from injected air. The preferred embodiment is inherently safer since the addition of oxygen by air in-leakage through condenser 230 and/or SJAE 235 is a passive addition and readily available during transient operation without complicated controls.

Notably, a wide variety of equipment types and specifications may be provided for feed water pumps 210, reactor vessel 220, turbine 225, condenser 230, steam jet air ejector 235, AOG System 245, and oxygen injection system 270. Any suitable equipment known to those skilled in the art may be used for these listed components.

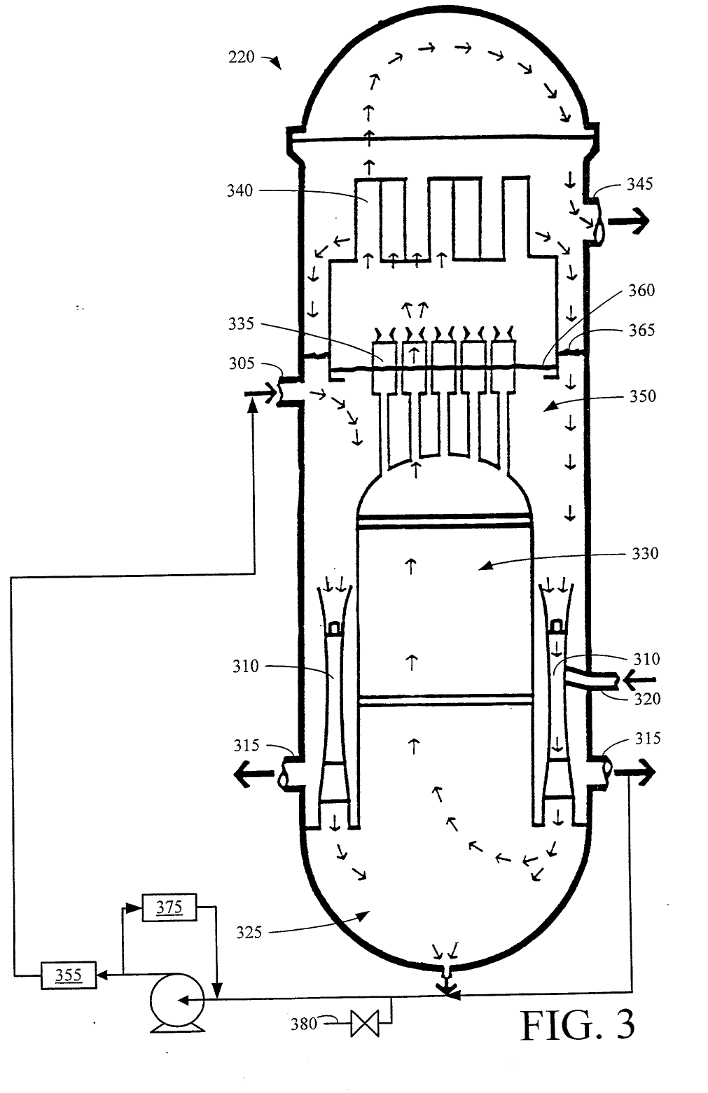

To control IGSCC, a hydrogen injection system 260 is provided. Hydrogen injection system 260 and oxygen injection system 270 are optional aspects of BWR system 200 since it is conceivable that the circumstances of a particular BWR system will not require such equipment. BWR system 200 further includes a N₂H₄ injection system 280 for practicing the method according to a preferred embodiment of the present invention. Preferably, N₂H₄ injection system 280 provides N₂H₄ at an effective location to react with H₂O₂ in BWR system 200 and to reduce the amount of H₂O₂ to a desired amount in vessel water entering a reactor core (shown in FIG. 3) of reactor vessel 220. Preferably, N₂H₄ is injected in at least one feed water line upstream of feed water distributors (not shown) inside reactor vessel 220 such that N₂H₄ laden feed water is applied at a location wherein H₂O₂ may be reduced in vessel water entering the reactor core of reactor vessel 220.

Notably, a variety of locations may be able to satisfy such criteria for N₂H₄ injection, even though FIG. 2 specifically shows N₂H₄ injection system 280 supplying N₂H₄ to a point upstream to feed water pumps 210. Other locations are conceivable in accordance with the features of the present invention described herein. For example, N₂H₄ is more preferably supplied such that the feed water distributers apply N₂H₄ laden feed water to liquid effluent returned from steam dryers/separators (shown in FIG. 3) to a mixing region of reactor vessel 220 in each occurrence. Most preferably, the feed water distributors indicated are feed water spargers as presently known to those skilled in the art and mixing region is mixing plenum inside reactor vessel 220 also as known to those skilled in the art.

Turning now to FIG. 3, a cross-sectional view of reactor vessel 220 is shown. FIG. 3 particularly shows the distribution and flow of water within reactor vessel 220. Preferably, feed water enters reactor vessel 220 at one or more feed water inlets 305 and is approximately evenly distributed within a mixing plenum 350. Such distribution is preferably accomplished using feed water spargers (not shown). Following distribution within mixing plenum 350, vessel water flows downward and is either recirculated from a recirculation loop suction 315 to a recirculation pump and returned to inlet 320 or is pumped by jet pump 310 into a below core region 325. While recirculation is typically used in conventional reactor vessels, it is conceivable that a recirculation loop as shown in FIG. 3 may include a suction or inlet positioned differently than shown, or that no recirculation is provided. As discussed below, the extent of recirculation is important when considering the residence time of vessel water within reactor vessel 220 prior to entry into a reactor core 330.

As also shown in FIG. 3, an outlet is provided within below core region 325 to send a portion of the vessel water to an optional reactor water cleanup unit (RWCU) 355 where selected undesirable components in the vessel water may be removed, for example, by using adsorptive resin or other systems. Vessel water thus cleaned is preferably returned to reactor vessel 220, typically through feed water 305. However, vessel water cleaned in RWCU 355 could alternatively be returned to a different part of reactor vessel 220 or BWR system 200. The outlet to RWCU 355 may be alternatively located at a different point on reactor vessel 220 or within BWR system 200 where feed water or steam dryer/separator liquid effluent may be cleaned up, although it is preferred that liquid effluent or water within reactor vessel 220 is cleaned up. FIG. 3 shows an additional outlet from recirculation loop suction 315 to RWCU 355 that may be operated in parallel with or in isolation from the outlet within below core region 325. That is, in the preferred embodiment shown in FIG. 3, vessel water may be removed from reactor vessel 220 either at below core region 325, at recirculation loop suction 315, or at both locations.

Preferably, as shown in FIG. 3, a RWCU pump 370 is provided to facilitate supplying vessel water to RWCU 355 and delivering cleaned vessel water to its next location, preferably reactor vessel 220. RWCU pump 370 may, however, be located differently than shown and still provide the described function. FIG. 3 also shows that it is preferable to provide an optional ECP unit 375 to perform measurement of ECP outside of reactor vessel 220. Any method known to those skilled in the art may be used in ECP unit 375 to determine vessel ECP. For example, probes may be installed to determine ECP by analyzing the vessel water removed to ECP unit 375 or ECP unit 375 may be simply another sampling point to collect vessel water for analysis in a separate testing unit. Determination of ECP may be performed solely by chemical analysis of the water or by a combination of chemical analysis and estimation of the properties of vessel water. In addition, a separate sampling station 380 is provided for any further sampling needs.

Vessel water flows from below core region 325 through reactor core 330 where it is boiled and heated to saturated steam. The saturated steam enters a steam separator 335, where water particles are removed, and then passes to a steam dryer 340 for further removal of non-gaseous water. The dried steam from steam dryer 340 passes through steam outlet 345 and on to turbine 225 as shown in FIG. 2, while the liquid effluent from steam separator 335 and steam dryer 340 flows down to mixing plenum 350. A typical water level 365 for mixing plenum 350 and a typical water level 360 for steam separator 335 are shown in FIG. 3.

As is known to those skilled in the art, a wide variety of compounds are generated within reactor core 330 as vessel water and water impurities are exposed to radiation. H₂ is one reducing species generated in reactor core 330 and O₂ and H₂O₂ are two oxidizing species generated in reactor core 330. As an example of the distribution of species, prior analysis has shown the following concentrations in liquid effluent passing from steam separator 335 and steam dryer 340 to mixing plenum 350:

TABLE 1
Species Distribution in Liquid Effluent

| | |
|---|---|
| 20 | parts per billion (ppb) (mass) H₂ |
| 175 | ppb O₂ |
| 500 | ppb H₂O₂ |

This distribution was determined from a BWR system when not using hydrogen injection for IGSCC control. As indicated earlier, addition of H₂ changes the vessel chemistry and accordingly would typically lower the concentration of O₂ below the concentration indicated. Further analysis under the same conditions produced the following concentrations for vessel water entering jet pump 310 after combining liquid effluent in mixing plenum 350 with feed water having an O₂ concentration of approximately 30 ppb:

TABLE 2
Species Distribution in Vessel Water to Jet Pump

| | |
|---|---|
| 2.0 | ppb H₂ |
| 200 | ppb O₂ |
| 80 | ppb H₂O₂ |

Still further analysis under the same conditions produced the following concentrations for vessel water in below core region 325:

TABLE 3
Species Distribution in Below Core Vessel Water

| | |
|---|---|
| 0.0 | ppbH₂ |
| 216 | ppb O₂ |
| 25 | ppb H₂O₂ |

Given the much higher concentration of O₂, compared to H₂O₂, one can readily understand the preoccupation in conventional methods for controlling IGSCC with H₂ injection and catalytic enhancement to reduce the concentration of O₂ through recombination with H₂.

Additionally, extensive testing and consideration of alternative chemical additives potentially useful in decreasing ECP (an indicator of the extent to which IGSCC will occur) has indicated that H₂ injection continues to be the favored chemistry control method. Such testing included evaluation of N₂H₄, however, it also proved ineffective and undesirable. While recognized as an efficient oxygen scavenger, the testing nevertheless showed that N₂H₄ produced the highest level of carryover of radioactive nitrogen (N¹⁶) than any other additive tested as a potential candidate for reducing ECP, and thus IGSCC. (“Development and Use of an In-Pile Loop for BWR Chemistry Studies,” MIT Nuclear Reactor Laboratory, Electric Power Research Institute, September 1993, pgs. 6-1 to 6-15.)

The focus in the testing was that N₂H₄ was targeted for reducing oxygen levels and was allowed to enter the reactor core. By contrast, the method according to a preferred embodiment of the present invention involves 1) selecting the amount of N₂H₄, the location of injection, and the residence time in reactor vessel 220 to target primarily the reduction in the level of H₂O₂ and 2) keeping N₂H₄ out of the reactor core. Using this approach, it can be seen that excellent results may be obtained in reducing IGSCC and improving monitoring of vessel chemistry without increasing N¹⁶ carryover into steam generated for power production. Achieving such beneficial results requires the realization that the reaction of N₂H₄ with H₂O₂ is predicted to occur at a rapid pace in a liquid phase to produce nitrogen (N₂) and water. Because of the high thermal energy levels present in the BWR system 200 environment, rapid reaction of N₂H₄ with H₂O₂ is expected to occur with or without the presence of a catalyst.

The combination of liquid N₂H₄ and liquid H₂O₂ has even been used as an important rocket propellant in the presence of ionic copper (Cu²⁺). However, the realization that the presence of Cu²⁺ catalyst may further enhance the reaction of N₂H₄ with H₂O₂ in a BWR has also been overlooked due to testing showing that the presence of Cu²⁺ interferes with the recombination of H₂ and O₂ to form water. Since the H₂/O₂ recombination is the primary reaction thought to be the key to reducing IGSCC, it is counterintuitive to realize that the presence of Cu²⁺ may nevertheless reduce IGSCC when H₂O₂ is targeted for reaction with N₂H₄.

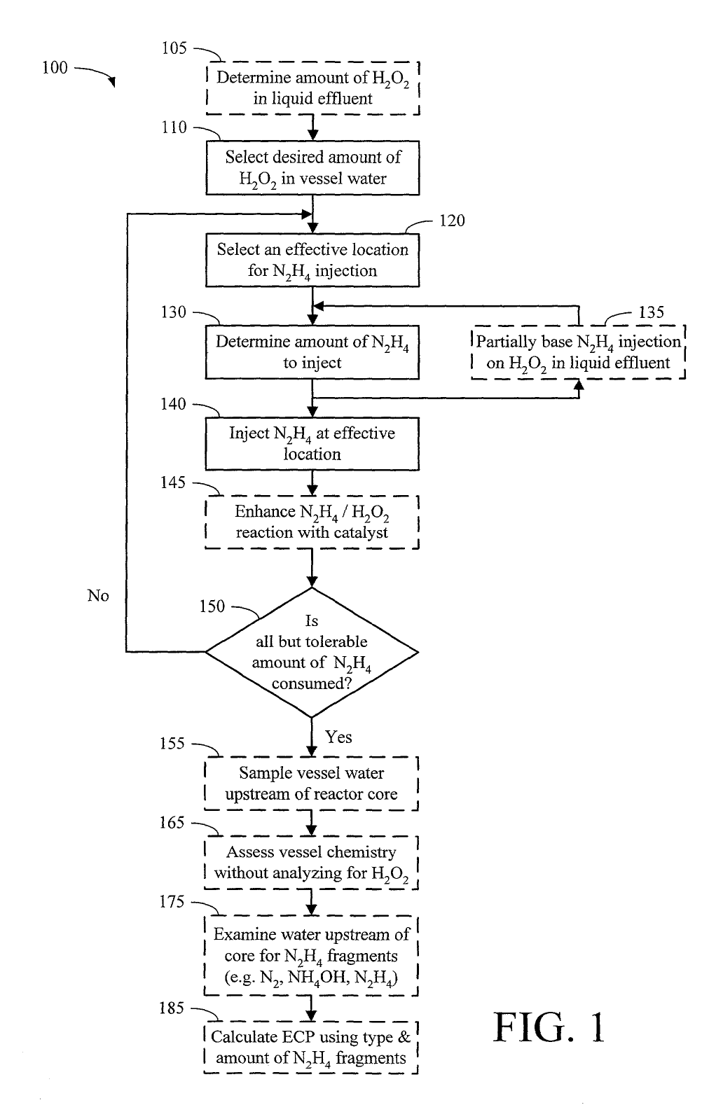

Turning now to FIG. 1, a diagram of the steps of a method according to a preferred embodiment of the present invention is shown. Method 100 is shown in FIG. 1 with basic steps 110, 120, 130, 140, and 150 as well as optional steps 105, 135, 155, 165, 175, and 185. Method 100 will first be discussed in terms of the basic steps and then further explanation will be provided regarding incorporation of optional steps into method 100. Steps 110, 120, 130, and 140 may be combined and summarized as the step of adding a sufficient amount of N₂H₄ at an effective location to react with H₂O₂ and to reduce an initial amount of H₂O₂ to a desired amount in vessel water entering a reactor core. However, there are several factors important in determining how much N₂H₄ to add and in selecting an effective location to accomplish the advantageous reduction of an initial amount of H₂O₂. Accordingly, method 100 shown in FIG. 1 breaks down the summarized step into at least four component parts.

First, in step 110, a desired amount of H₂O₂ that is acceptable in vessel water entering reactor core 330 is selected. Preferably, the desired concentration of H₂O₂ in below core region 325 should be less than approximately 5 ppb. However, it is conceivable that other limits on the desired amount of H₂O₂ may be advisable. For example, instead of a concentration limit in parts per billion, it may be desirable to express the limitation on H₂O₂ amount as a mass flow rate, such as pounds per hour. Also, the limitation of 5 ppb H₂O₂ reflects a desire to reduce H₂O₂ to a de minimis level, but it is conceivable that some specified amount of H₂O₂ greater than 5 ppb may be acceptable in a particular BWR system. Accordingly, a de minimis amount for a particular BWR system may be greater than 5 ppb or it may be acceptable for vessel water entering reactor core 330 to contain more than a de minimis amount. Such selections may be made on a case-by-case basis for an individual reactor vessel 220, but generally, it is preferred to reduce H₂O₂ to less than approximately 5 ppb or an equivalent mass flow rate depending upon the flow rate of vessel water.

Step 120 of method 100 involves selecting an effective location such that injected N₂H₄ will react with H₂O₂ to reduce the initial amount to the desired amount discussed above. Consideration must be given to the location inside reactor vessel 220 where favorable conditions for the reaction exist and where N₂H₄ can be added in BWR system 200 to reach the region for favorable reaction. As demonstrated by the data presented above, the most significant source for H₂O₂ in reactor vessel 220 is from the liquid effluent discharged from steam separator 335 and steam dryer 340. Accordingly, a preferable location for the reaction to occur is wherever injected N₂H₄ can be quickly mixed with steam dryer/separator liquid effluent flowing from steam separator 335 and steam dryer 340 to mixing plenum 350. Mixing the components quickly helps to prevent limitation of the reaction rate due to unavailability of the reactants when inadequate mixing occurs. It has been discovered that adequate mixing occurs when hydrazine is supplied through feed water inlet 305 as a mixture with feed water and distributed throughout mixing plenum 350 by feed water spargers (not shown).

As presented above, the reaction of N₂H₄ with H₂O₂ has been used as rocket propellant in the presence of Cu²⁺ catalyst, thus, it can be estimated to occur almost instantaneously for the present purposes given the very low concentration of H₂O₂ and the complete mixing of N₂H₄ laden feed water with H₂O₂ in liquid effluent. Consideration must be given however to several competing factors. First, the temperature and radiation exposure under which the reaction occurs will both influence reaction rate. Second, depending on the reaction rate of N₂H₄ with O₂ in the feed water that delivers the N₂H₄ to mixing plenum 350, part of the N₂H₄ may be prematurely consumed. As is known to those skilled in the art, the rate of a reaction is typically influenced by temperature, pressure, concentration of the reactants and the products, pH, catalysts, and other conditions.

Given the typical operating conditions of BWR system 200, as described in the patents incorporated by reference above, and a typically low oxygen concentration in feed water of approximately 30 ppb, the reaction rate of N₂H₄ with O₂ can be assumed to be relatively slow. Further, previous testing has shown the ineffectiveness in a BWR of N₂H₄ as an O₂ reducer, thus, for a residence time of 90 seconds or less in feed water prior to encountering the H₂O₂ reaction region, it can be assumed that the depletion of N₂H₄ by reacting with O₂ is minimal. A detailed evaluation of this assumption is provided in the examples below. Nevertheless, it is conceivable that conditions may be encountered where additional N₂H₄ must be added to account for depletion of N₂H₄ by the reaction with O₂ such that a sufficient amount of N₂H₄ is delivered to the region where the primary reaction with H₂O₂ will occur. Such a calculation of additional needed N₂H₄ is within the knowledge of those skilled in the art given the disclosure provided herein and the knowledge available concerning the N₂H₄/O₂ reaction. For some BWR systems, it may even be desirable to add enough extra N₂H₄ to achieve some limited consumption of O₂ with N₂H₄ after virtually all of the H₂O₂ has been consumed in the H₂O₂ reaction region. The N₂H₄ used for O₂ scavenging may even be injected at a different location than that used for H₂O₂ scavenging, for example, one alternate location is the suction to a recirculation pump.

Accordingly, selection of the injection location in step 120 of method 100 may be considered to be closely intertwined with step 130 of determining the amount of N₂H₄ to add. Once given the desired amount of H₂O₂ for vessel water entering reactor core 330 and the N₂H₄ injection location, other factors must be considered to select the amount of N₂H₄ to inject. First, consideration should be given to the amount of H₂O₂ present in the reaction region. For example, the data presented above indicated a typical concentration of 500 ppb for liquid effluent in mixing plenum 350 prior to mixing with feed water from feed water inlet 305. Obviously, the actual amount of H₂O₂ present will depend upon the design and operating conditions of a particular BWR system and may be determined through vessel water analysis and/or empirical estimation. Knowing the amount of H₂O₂ present in the reaction region, the target for the reduced amount of H₂O₂, and any needed excess to counteract reaction with O₂ in the feed water should provide sufficient information to determine a sufficient amount of N₂H₄ to inject. Nevertheless, additional amounts of N₂H₄ may be desirable depending upon the vessel chemistry scenario selected for reactor vessel 220.

As stated above, it is preferable to reduce the amount of H₂O₂ to less than 5 ppb, however, there may be circumstances where a higher or lower limitation is desired. Also, it may be desirable to additionally react N₂H₄ with O₂ in the reaction region to reduce an initial amount of O₂ to a desired amount in vessel water entering the reactor core. As stated earlier, the reaction rate of N₂H₄ and O₂ in feed water can be considered relatively slow. However, the concentration of O₂ and other conditions, such as temperature and pressure, may be sufficiently higher in the vessel water to produce an increased reaction rate that would not be considered minimal. For example, an O₂ concentration of 175 to 225 ppb is typical in vessel water. Given the possibility of decreasing the amount of O₂ along with the amount of H₂O₂, additional N₂H₄ may be injected to accomplish the reduction.

Next, step 140 of method 100 involves injecting a sufficient amount of N₂H₄ to achieve the effects selected in the steps above. In step 150, a determination is made whether sufficient residence time was provided to consume all but a tolerable amount of the N₂H₄ prior to the treated vessel water entering reactor core 330. If a determination is made that the tolerance of BWR system 200 to byproducts that result from the presence of N₂H₄ in reactor core 330 has been exceeded, then steps 120 and 130 should be reconsidered to meet the needed tolerance level. Preferably, for most BWR systems, consuming all but a tolerable amount of the N₂H₄ will require consuming substantially all of the N₂H₄. More preferably, consuming substantially all of the N₂H₄ should yield less than approximately 5 ppb N₂H₄ in vessel water entering reactor core 330.

Nevertheless, it is conceivable that BWR system 200 may be more or less tolerant of N₂H₄ such that a higher or lower limit may be met while still being able to consider the decomposition of N₂H₄ to produce a de minimis amount of N¹⁶ in steam supplied to turbine 225. Thus, yet another vessel chemistry scenario provides reduction of H₂O₂ to a desired amount, and reduction of O₂ to a desired amount and leaving somewhat more than 5 ppb N₂H₄ in vessel water entering reactor core 330. If the inquiry of step 150 is satisfied, then the basic steps of method 100 are considered complete.

The optional steps of method 100 shown in FIG. 1 may be incorporated into the basic method described above depending upon the need for and desirability of such additional steps for a given BWR system. In optional step 105, a determination may be made as to the initial amount of H₂O₂ in liquid effluent returned from steam separator 335 and steam dryer 340 for combination with the feed water in mixing plenum 350. This information may then be used in optional step 135 to select the sufficient amount of N₂H₄ at least partially based upon the initial amount of H₂O₂ in the liquid effluent. In the conventional methods for reducing IGSCC discussed above, no significant consideration has been given to targeting the H₂O₂ in steam dryer/separator liquid effluent for rapid reaction with N₂H₄. Thus, optional step 105 presents another shift from the practice in conventional methods and helps enable some of the advantages discussed herein.

FIG. 1 also shows optional step 145 of enhancing the reaction of N₂H₄ with H₂O₂ by using a catalyst. It is conceivable that a variety of catalysts (such as those including elements from the noble metal group) could potentially enhance the reaction. However, Cu²⁺ is known to catalyze the N₂H₄/H₂O₂ reaction when the reactants are used as rocket propellant. Further, the vessel water of a BWR system may contain a catalytically effective amount of minerals such as Cu²⁺ and not require the addition of a separate catalyst. It is estimated that between 5 to 15 ppb Cu²⁺ is a catalytically effective amount of one mineral that can further catalyze the N₂H₄/H₂O₂ reaction.

One of the advantages of a preferred embodiment of the present invention is that it may be used in combination with conventional methods for reducing IGSCC, such as use of a noble metal catalyst, for example, platinum and/or rhodium, to promote combination of H₂ and O₂ to form H₂O. The preferred embodiment is predicted to be compatible with the conventional method of promoting H₂/O₂ recombination by adding excess H₂. Both of these conventional methods are disclosed in the patents herein incorporated by reference above.

Aside from reducing IGSCC when controlling vessel chemistry of BWR system 200 as described above, method 100 may also be used to improve the cost effectiveness of monitoring vessel chemistry. Accordingly, optional step 155 includes collecting a sample of vessel water upstream of the reactor core and optional step 165 includes obtaining a complete assessment of vessel chemistry by analyzing the sample only for the presence of components other than H₂O₂. This sampling may be accomplished by drawing a sample of vessel water at sample station 380 shown in FIG. 3 or another sample station and analyzing for N₂H₄ fragments and ECP as discussed below. Alternatively, the sampling may be accomplished by providing ECP unit 375 stationed outside reactor vessel 220 where it can be readily accessed for data collection and maintenance needs. Further, still other sampling and analysis methodologies as known to those skilled in the art may be used.

The two additional steps (155 and 165) are enabled by the other steps of method 100 because H₂O₂ may be targeted for removal prior to vessel water entering the reactor core. One of the problems in monitoring vessel chemistry is that H₂O₂ is extremely difficult to measure in an BWR vessel because thermal decomposition and decomposition induced by contact with the walls of sample lines combine to produce hard-to-measure concentrations of this species in a BWR system 200. Accordingly, the amount of H₂O₂ in mixing plenum 350 can be assessed and estimated as close as possible and then reacted with a known amount of N₂H₄ according to method 100. Since the amount of O₂ is also known, testing below core region 325 for the presence of O₂ will indicate whether the correct amount of N₂H₄ was added for the estimated amount of H₂O₂. If too little H₂O₂ was estimated, then the excess N₂H₄ will react with and reduce the amount of O₂, producing an O₂ amount in below core region 325 that is less than the O₂ in mixing plenum 350. Accordingly then, steps 155 and 165 may be used to ensure that the components in the vessel water are correctly assessed or may additionally be used to ensure that the presence of H₂O₂ in mixing plenum 350 is correctly assessed.

Optional steps 175 and 185 in combination with the basic steps of method 100 provide yet another advantage in controlling vessel chemistry of BWR system 200. In optional step 175, vessel water upstream of reactor core 330 is examined to assess the type and amount of N₂H₄ fragments, such as N₂, ammonium hydroxide (from ammonia), and unreacted N₂H₄, and the information obtained is used in optional step 185 of calculating ECP from the type and amount of N₂H₄ fragments. Accordingly then, steps 175 and 185 enable using N₂H₄ injection as set forth in method 100 as a tool to determine the ECP within reactor vessel 220. The approach involves first establishing a baseline of vessel chemistry in below core region 325. The baseline should provide an indication of ECP in relation to the chemical components of vessel water in below core region 325. Next, a new baseline of vessel chemistry in below core region 325 is established while using N₂H₄ injection. Preferably, the process could be partially baselined by testing N₂H₄/H₂O₂ reactions offline under laboratory conditions. The new baseline should also provide an indication of ECP in relation to the chemical components, in particular N₂H₄ fragments.

In keeping with the vessel chemistry scenarios described above, different injection rates of N₂H₄ will yield different amount and/or types of components. By using the first baseline and the new baseline, ECP may be calculated or measured based on the amount and types of components present in below core region 325. For example, if no N₂H₄ or ammonium hydroxide fragments are found and H₂O₂ is totally consumed, then ECP may be determined by considering the amount of O₂ present in the offline sample. If N₂H₄ fragments exist, then the ratio of fragments will inform of the H₂, O₂, and H₂O₂ distributions. Such distributions can then be used to calculate ECP.

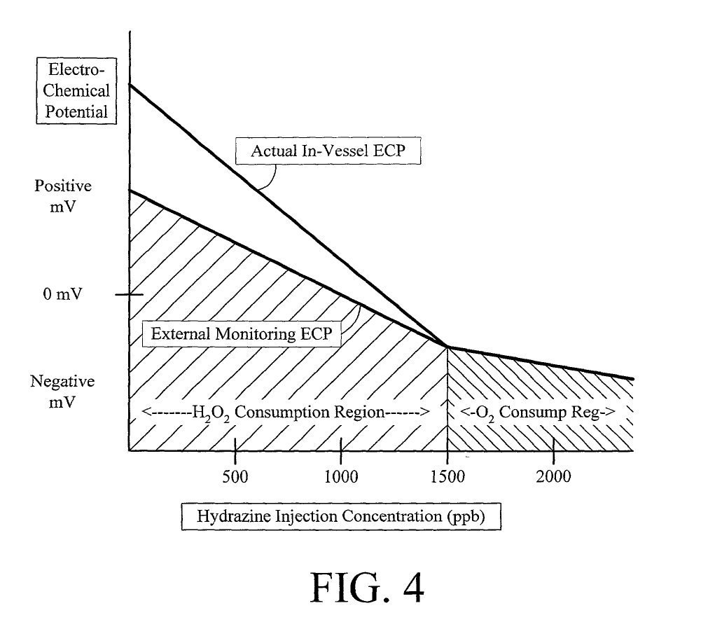

An example of one way in which the baselining data may be presented is shown in the graph of FIG. 4 plotting N₂H₄ concentration in feed water against ECP. Notably, for this example, up to about 1500 ppb N₂H₄ substantially all of the N₂H₄ is consumed primarily by reaction with H₂O₂, but with little impact on O₂ concentration. The concentration of N₂H₄ in feed water on the x-axis will determine the concentration of residual H₂O₂ that remains in vessel water after all the N₂H₄ is consumed. As the concentration N₂H₄ in feed water rises up to 1500 ppb, the concentration of residual H₂O₂ decreases to zero at the point where enough N₂H₄ is present to consume all of the H₂O₂. At the point where all H₂O₂ is consumed (approximately 1500 ppb N₂H₄) the actual ECP inside reactor vessel 220 is the same as the ECP determined by external monitoring using one of the methods described above. If less than 1500 ppb N₂H₄ is provided in the feed water, then residual H₂O₂ will exist in vessel water and the in-vessel ECP will be greater than the ECP indicated by external monitoring. If more than 1500 ppb N₂H₄ is provided in the feed water, then at least a portion of the O₂ in vessel water will be consumed, further decreasing ECP. Noticeably, however, in-vessel and external ECP are the same once all the H₂O₂ is consumed as is the case for N₂H₄ concentrations above 1500 ppb in the example described in FIG. 4.

FIG. 4 thus shows the difference between in-vessel and external ECP in a qualitative fashion as a function of N₂H₄ concentration in feed water. Such a graph may be produced for any BWR after collecting the data from baselining as described above. Once developed, a graph such as FIG. 4 may be used to estimate in-vessel ECP based only on the concentration of N₂H₄ in feed water. The estimate may be checked by external monitoring of ECP to verify that the predicted external ECP is obtained. If the predicted and actual external ECP match, then the in-vessel ECP is confirmed. If the predicted and actual external ECP do not match, then some parameter on which FIG. 4 is based, such as the concentration of O₂ or H₂O₂ in vessel water prior to reaction with N₂H₄ may have changed and a new graph such as FIG. 4 may be required.

In keeping with the above principles described for the preferred embodiments of the present invention, examples of how such principles are used to practice the invention are set forth below.

### EXAMPLE 1

### Hydrogen Usage Rate and Radioactive Dose Rate

For normal hydrogen water chemistry (injection of hydrogen to control IGSCC) to achieve protection, current technology requires significant excess hydrogen. For example, 27 ppb of excess hydrogen is needed to stoichiometrically react with 216 ppb of oxygen according to the reaction 2H₂+O₂=2H₂O and Table 3. However, typical field experience shows that required hydrogen levels for below core region 325 range between 15 50 ppb to 250 ppb. In other words, about 2 to 9 times the stoichiometric concentration of hydrogen is needed for protection. Additionally, this excess hydrogen encourages radioactive ammonia formation, which can raise steam line radioactive dose rates by a factor of 5.

For hydrogen addition with noble metal catalysis, field experience shows that protection can be achieved with hydrogen additions between 0.9 to 2 times stoichiometric values. The reduced hydrogen addition requirement significantly reduces radiation dose rate in most BWRs. However, the dose increase caused by hydrogen injection may still be significant if copper ions are present in the water. For example, dose rate increases may be as low as 0% with stoichiometric hydrogen additions, but dose rate may double if 2 times the stoichiometric amount of hydrogen is injected, and 5 to 15 ppb copper ions are present in vessel water.

For hydrazine chemistry (injection of N₂H₄ to control IGSCC) as described herein, N₂H₄ may be injected to react with H₂O₂ and, possibly, O₂ to create a favorable ECP in the reactor vessel and lower crack growth rates. If all of the added N₂H₄ is consumed prior to the vessel water entering the reactor core, the hydrogen atoms in N₂H₄ are not available to form radioactive ammonia and increase radiation dose rate. Copper ion (if present) is beneficial in reducing dose rate, rather than detrimental as with hydrogen/noble metal water chemistry, since copper ion tends to catalyze the N₂H₄ reaction to proceed more rapidly. Rapid consumption of N₂H₄ helps to further ensure that intolerable amounts of N₂H₄ are not allowed into the reactor core. Hydrazine chemistry thus reduces the excess hydrogen available to form radioactive ammonia, thereby keeping radioactive doses low (e.g. projected between 0% and 5% increase). Hydrazine water chemistry is also predicted to work with noble metals chemistry, yielding similar ECP benefits but with low radioactive ammonia formation.

### EXAMPLE 2

### Adequacy of Air In-leakage and Hydrazine Usage Rates

The current technology for both hydrogen water chemistry and hydrogen/noble metals water chemistry require a separate, significant oxygen source to recombine excess hydrogen that is not recombined in the reactor vessel. This technology requires sophisticated control systems to avoid accumulations of hydrogen which could cause detonations. It also requires the purchase of oxygen, which increases the cost of operation.

The hydrazine/hydrogen peroxide reaction is predicted to be very nearly complete in BWR reactor vessel 200. The excess hydrogen that is formed will be supplied primarily from steam dryer/separator liquid effluent and some incomplete hydrazine/hydrogen peroxide reaction. This excess hydrogen volume is predicted to be much smaller than either of the current technologies, and therefore can be totally recombined with oxygen available from condenser air in-leakage before being sent to AOG System 245.

For example, if 1500 ppb hydrazine is added to feed water (flow rate=2.9×10⁶ kilograms/hour (kg/hr) (6.4×10⁶ pounds/hour (lbs/hr))) to create a pre-reaction concentration of 237 ppb hydrazine in the mixing plenum, then 500 ppb hydrogen peroxide can be consumed. This represents a hydrazine addition rate 4.47 kg/hr (9.85 lbs/hr). The equivalent hydrogen concentration contained within the hydrazine is about 200 ppb at feed water flow rates. If all this hydrogen remained uncombined (an unexpected occurrence), the oxygen available from a typical condenser air in-leakage rate of 0.42 cubic meters/minute (cmm) (15 cubic feet/minute (cfm)), would consume the hydrogen with approximately at 15% oxygen volume excess. Although it is recommended to provide a port for oxygen (or air) addition after the condenser, it is anticipated that additional oxygen will not be regularly needed for hydrazine water chemistry. Since oxygen addition is passively accomplished with air in-leakage, the control system is much simpler, and the cost of controls is reduced.

### EXAMPLE 3

### Relative Cost Comparisons

The consumption rate of hydrazine for a BWR system is significant but manageable and can be achieved using portable equipment at a modest rental fee. Although the operating costs are estimated to be up to 5 times more than a hydrogen injection system, the significant savings is realized in capital expenditures. It is estimated that hydrazine capital equipment costs are approximately 30 to 70 times less than a hydrogen injection system. The primary reasons are simpler control equipment and smaller equipment footprint. A hydrazine addition system may be more cost effective for up to 20 years. However, to achieve this favorable balance, both ECP field performance and reactor water cleanup resin usage (to address hydrazine impurities) of the hydrazine addition system must be verified.

### EXAMPLE 4

### Residence Times of Hydrazine in BWR Components

For a BWR reactor vessel, vessel water can enter the below core region rapidly when it is “driven” directly through the jet pumps. When this flow path is taken, there is approximately 10 to 15 seconds (sec) for a reaction to take place before excess N₂H₄ potentially enters the reactor core. Hydrazine can adequately react with H₂O₂ during this time, but will only partially react with oxygen which requires about 30 sec at 200° C. to 230° C. (400° F. to 450° F.). For this reason, H₂O₂ is the primary target. Since H₂O₂ is considered the more aggressive oxidizer, and a significant source of oxygen to the below core region (e.g. supplies approximately 40% to 50% of the O₂ when it breaks down from H₂O₂ to water and oxygen), eliminating hydrogen peroxide in the mixing plenum will have a significant effect on improving ECP in the downcomer, recirculation, and below core regions of a reactor vessel.

Hydrazine may also react with O₂ in the feed stream (normally feed water 305 of FIG. 3). Depending on plant configurations, residence times will vary significantly but nominally between 30 to 50 sec. Since 1) oxygen concentrations are typically low in feed water streams (nominally 30 ppb) and 2) temperatures are below optimum hydrazine reaction temperature of hydrazine at about 200° C. (400° F.) for most of the piping run, consumption of hydrazine before entering the vessel mixing plenum is considered typically low.

### EXAMPLE 5

### Survival Rate of Hydrazine in the Reactor Vessel

The N₂H₄ injection rate is targeted such that 1) most N₂H₄ remains unreacted until it reaches the mixing plenum, 2) adequate N₂H₄ may be provided to react with H₂O₂ in the liquid effluent from steam separators and steam dryers, and 3) a small excess may be supplied to provide limited O₂ reduction. Since the N₂H₄/H₂O₂ reaction is judged to be near instantaneous, it is estimated that 10 to 15 sec is adequate for near complete consumption, but may be limited by mechanical mixing capability. Hydrazine begins to break down from thermal exposure at about 200° C. (400° F.) and the below reactor core residence time of 10 to 15 sec is less than the about 30 sec needed for a complete N₂H₄/O₂ reaction at 200° C. to 230° C. (400° F. to 450° F.). Thus, it is estimated that only 33% of the available O₂ will react with N₂H₄ before entering the reactor core. Therefore, it is necessary to keep targeted O₂ amounts small, to avoid carryover of N₂H₄ to the core with consequential undesirable decomposition within the reactor core.

### EXAMPLE 6

### Method for Injecting Hydrazine to Scavenge H₂O and O₂

In reference to the method shown in FIG. 1, the following example explains one method for determining the proper amount of hydrazine (and catalyst) needed to scavenge hydrogen peroxide and oxygen in a BWR. One goal of the method is to scavenge these oxidizers to provide IGSCC protection without a significant increase in main steam line doses.

1 Determine Amount of H₂O₂ in Liquid Effluent (Step 105):

Prior art has shown that water discharge from moisture dryers and separators (335 and 340), has the following typical approximate concentrations: H₂=20 ppb; O₂=175 ppb; H₂O₂=500 ppb.

2. Select Desired Amount of Residual H₂O₂ to Remain (Step 110):

It is most preferable to remove 100% of the H₂O₂ if possible since it is a significant liquid oxidant. Therefore the first estimate should assume an ideal stoiciometric mix of N₂H₄ to consume all H₂O₂ in a complete reaction. If the reaction is not nearly 100% complete, the decision of an acceptable H₂O₂ residual must be made. The quantity of acceptable residual depends on whether: a) acceptable ECPs are achieved (e.g. ECP=−230 mev or lower); b) constant or small increases in main steam line dose rates are achieved; and c) the auto breakdown rate of H₂O₂ to water and O₂ (a second parallel reaction) is confirmed significant. The N₂H₄ rapidly consumes O₂ (even at low concentrations), and significant oxidant can be removed by this second parallel reaction.

If an acceptable ECP is not achieved through this process, indicating that both N₂H₄/H₂O₂ and H₂O₂ auto breakdown reactions are slower than anticipated, a catalyst must be added and/or increased to make the N₂H₄—H₂O₂ reaction more effective.

3. Select an Effective Injection Location (Step 120):

The N₂H₄ must be injected in a location such that it remains stable until it encounters H₂O₂. One example of an effective injection location is the feedwater (FW) system (FIG. 2, 280 into 210). The FW injection point is generally effective because:

a. FW temperatures are lower than reactor vessel temperatures (300 F to 375 F) so that the N₂H₄ is not as actively scavenging residual O₂ in the FW system. This can be seen by the following equation which estimates the hydrozine-oxygen reaction kinetics at a given temperature T (° K):

$$log k = - 3.8 - ( \frac{1}{T * {10}^{- 3}} - 3.2 ) , \\ where k = first order rate coefficient ( {sec}^{- 1} ) .$$

As is evident by the foregoing equation, for the temperatures in the FW line, the reaction rate is approximately 10,000 times slower in the FW line than it is in the vessel. This slower reaction rate helps maintain protective films on carbon steel pipe in the FW system where it is required to be at 30 ppb or higher and preserves N₂H₄ for the target point (e.g. moisture separator and dryer effluent at the FW nozzles).

b. There is no H₂O₂ in the feedwater stream to consume (which further preserves N₂H₄ until needed).

c. Vessel temperatures are typically about 527° F. Studies have shown that N₂H₄ is stable and active in this high temperature region, and ready to consume H₂O₂, where concentrations are highest and the initial reaction is vigorous.

4. Determine the Amount of N₂H₄ to Inject (Step 130):

The amount of N₂H₄ to inject is determined by molar ratio from known reactions:

N₂H₄+2H₂O₂=N₂+4H₂O

N₂H₄+O₂=N₂+2H₂O,

and conversion of weight concentrations into molar concentrations:

$${H}_{2} = ( \frac{20 lbs {H}_{2}}{1 billion lbs mixture} ) \times ( \frac{1 lb mole {H}_{2}}{2 lbs {H}_{2}} ) = \frac{10 lb moles}{1 billion lbs mixture}$$

$${O}_{2} = ( \frac{175 lbs {O}_{2}}{1 billion lbs mixture} ) \times ( \frac{1 lb mole {O}_{2}}{32 lbs {O}_{2}} ) = \frac{5.47 lb moles}{1 billion lbs mixture}$$

$${H}_{2} {O}_{2} = ( \frac{500 lbs {H}_{2} {O}_{2}}{1 billion lbs mixture} ) \times ( \frac{1 lb mole {H}_{2} {O}_{2}}{34 lbs {H}_{2} {O}_{2}} ) = \frac{14.7 lb moles}{1 billion lbs mixture}$$

The N₂H₄ required equals that molar quantity needed to consume both O₂ (regularly performed for fossil boilers) and the H₂O₂ (that substance which is not present in fossil boilers but is present in nuclear boilers). In other words, we need: 5.47 lbmoles N₂H₄ per billion lbs mix to neutralize O₂; 7.4 lbmoles N₂H₄ (e.g. 14.7/2 ) per 1 billion lbs mix to neutralize H₂O₂ and the N₂H₄ needed to achieve stoiciometric balance (e.g. 12.82 ibmoles N₂H₄, or 410 ppb N₂H₄). Flow weighting factors may be applied to adjust for differences in FW flow rates and internal core flow rates which are approximately four times higher.

5. If Possible Enhance the Reaction with a Catalyst (Step 145):

Although the N₂H₄/H₂O₂ reaction is thermodynamically very favorable, the dilute concentrations (ppb range) significantly slow down reaction times. Since the allowable reaction time is short (approximately 10 to 15 seconds), the use of catalysts to accelerate the reactions is preferable. For some reactors, catalysts may already exist. For example, in a typical plant that uses an admiralty condenser, 6 ppb Cu⁺² (10E-07 molar) or more may be present in its reactor vessel. This catalyst may significantly catalyze the desired reaction at BWR temperatures. The consumption rate for N₂H₄ can be described as a first order equation dependent on Cu⁺² concentration and H₂O₂ concentration. When adjusted for temperature of the BWR (by Arrhenius method), the reaction rate may reach approximately 500 times the reaction rate of that at near room temperatures, e.g.:

$$\begin{matrix}\frac{ⅆ [ {N}_{2} {H}_{4} ]}{ⅆ t} = k [ Cu ] [ {H}_{2} {O}_{2} ] = \frac{10 , 000}{M sec} [ {10}^{- 7} M ] [ {10}^{- 5} M ] \\ = {10}^{- 8} \frac{M}{sec} = 3.2 \frac{ppd}{sec} {N}_{2} {H}_{4} consumed\end{matrix}$$

Since 2 moles of H₂O₂ are consumed per mole of N₂H₄ then:

$$\begin{matrix}\frac{ⅆ [ {H}_{2} {O}_{2} ]}{ⅆ t} = \frac{3.2 lbs {N}_{2} {H}_{4} consumed}{1 billion lbs solution} \times \frac{1 lb mole {N}_{2} {H}_{4}}{32 lb {N}_{2} {H}_{4}} \times \\ \frac{2 {H}_{2} {O}_{2} lb mole}{1 {H}_{2} {O}_{2} lb mole} \times \frac{34 lbs {H}_{2} {O}_{2}}{1 lb mole {H}_{2} {O}_{4}} \\ = \frac{6.8 ppb H2O2}{sec} . \end{matrix}$$

Therefore, for a 15 sec period, and 6 ppb Cu⁺² concentration in the reactor, typical H₂O₂ could be crudely approximated by:

$$\frac{6.8 ppb {H}_{2} {O}_{2}}{sec} consumption \times 15 seconds = 102 ppb {H}_{2} {O}_{2} consumption .$$

At this rate, only about 20% of the H₂O₂ would be consumed and this reaction alone would result in carryover of residual N₂H₄ to the core. Ordinarily, this would be unacceptable. However, with the parallel breakdown reaction of H₂O₂ to water and O₂, and the subsequent rapid consumption of O₂ by remaining N₂H₄, as indicated by the equations shown herein, it is anticipated that this pairing of reactions will result in only minute amounts of H₂O₂ and N₂H₄ reaching the core.

Reaction rates may be additionally improved if the concentration of the catalyst is increased. These improvements may result from the presence of platinum and rhodium from other catalytic ventures, or from a specialty equivalent organic catalyst supplied by the hydrazine vendors. Additionally, the annulus and recirculation pipe region is exposed to a relatively high gamma field which can provide additional activation energy to accelerate the reactions, as it does for the conventional H₂/O₂ reaction to form water in this region.

Applicant's studies indicate that the consumption rate of O₂ with N₂H₄ can be expressed by O₂ half life. At 500° F., the half life of O₂ with N₂H₄ is approximately 0.06 seconds. Therefore, there are approximately 250 half lives in the 15 seconds of allowable reaction time, and virtually all O₂ (and N₂H₄ used to consume it) will be consumed before reaching the core.

6. Inject the Prescribed N2H4 and Measure Results (Step 130, and Steps 150 Through 185):

Based on steps 1-5 above, the ideal N₂H₄ concentration may be determined. To ensure that proper vessel dynamics are established, the following iterative procedure should be considered:

a. Target initial injection at 10% of this ideal concentration and subsequently increase N₂H₄ by approximately 10% increments (or any other increments) to 100% of the amount determined through steps 1-5 to ensure minimum system impact.

b. Monitor main steam line radiation dose rates during this time period, to ensure steady values. If the reaction is 100% effective, no dose increase will result. Dose rates will increase if the reaction is not 100% effective.

c. Monitor advanced offgas system (AOG) offgas for increases in N₂ concentration. If the reaction is nearly 100% effective, the N₂ formerly contained in the N₂H₄ will flow through the reactor and not form soluble nitrates. A mass balance of gaseous N₂ from N₂H₄ recombination and air in-leakage can then be used to verify success.

d. Monitor Reactor Water Cleanup for N₂H₄ fragments (primarily soluable nitrates). The lack of an increase in soluble nitrates indicates the consumption reaction is effective.

e. If available, measure ECP. IGSCC protection is achieved if ECP is less than −230 mev.

While the invention has been particularly shown and described with reference to preferred embodiments thereof, it will be understood by those skilled in the art that various changes in form and details may be made therein without departing from the spirit and scope of the invention. Accordingly, unless otherwise specified, any dimensions of the apparatus indicated in the drawings or herein are given as an example of possible dimensions and not as a limitation. Similarly, unless otherwise specified, any sequence of steps of the method indicated in the drawings or herein are given as an example of a possible sequence and not as a limitation.

1. A method for controlling vessel chemistry of a boiling water reactor (BWR), comprising the steps of:
adding a sufficient amount of N₂H₄ at an effective location to react with H₂O₂ and to reduce an initial amount of H₂O₂ to a desired amount in vessel water entering a reactor core; and
providing a sufficient residence time to consume all but a tolerable amount of the added N₂H₄ prior to the vessel water entering a reactor core.

2. The method of claim 1, further comprising the steps of:
determining the initial amount of H₂O₂ in liquid effluent returned for combination with the feed water; and
selecting the sufficient amount of N₂H₄ at least partially based upon the initial amount of H₂O₂ in the liquid effluent.

3. The method of claim 1, wherein the desired amount of H₂O₂ yields less than approximately 5 part per billion (mass) H₂O₂ in vessel water entering the reactor core.

4. The method of claim 1, wherein the added amount of N₂H₄ comprises a sufficient amount to react additionally with O₂ to reduce an initial amount of O₂ to a desired amount in vessel water entering the reactor core.

5. The method of claim 4, wherein the desired amount of O₂ corresponds to a maximum reduction in the initial amount of O₂ that can be obtained while still consuming all but a tolerable amount of the added N₂H₄ prior to the vessel water entering a reactor core.

6. The method of claim 1, wherein the effective location comprises at least one feed water line upstream of feed water distributors such that N₂H₄ laden feed water is applied to returned liquid effluent in a mixing region of the vessel.

7. The method of claim 6, wherein the feed water distributors comprise feed water spargers and the mixing region comprises a mixing plenum.

8. The method of claim 1, further comprising the step of enhancing the reaction of N₂H₄ with H₂O₂ by using a catalyst.

9. The method of claim 8, wherein the catalyst comprises Cu2+ ions in the feed water.

10. The method of claim 1, further comprising the step of promoting combination of H₂ with O₂ to form H₂O by using a noble metal catalyst.

11. The method of claim 1, further comprising the step of promoting combination of H₂ with O₂ to form H₂O by adding excess H₂.

12. The method of claim 1, wherein consuming all but a tolerable amount of the added N₂H₄ comprises consuming substantially all of the added N₂H₄.

13. The method of claim 12, wherein consuming substantially all of the added N₂H₄ yields less than approximately 5 part per billion (mass) N₂H₄ in vessel water entering the reactor core.

14. The method of claim 1, further comprising the steps of:
examining vessel water upstream of the reactor core to assess the type and amount of N₂H₄ fragments; and
calculating electrochemical corrosion potential from the type and amount of N₂H₄ fragments.

15. The method of claim 1, further comprising the steps of:
collecting a sample of vessel water upstream of the reactor core; and
obtaining a complete assessment of vessel chemistry by analyzing the sample only for the presence of components other than H₂O₂.

16. A method for controlling vessel chemistry of a boiling water reactor (BWR), comprising the steps of:
determining the initial amount of H₂O₂ in liquid effluent returned for combination with feed water;
adding a sufficient amount of N₂H₄, as selected at least partially based upon the initial amount of H₂O₂ in the liquid effluent, at an effective location to react with H₂O₂ and to reduce an initial amount of H₂O₂ to a desired amount in vessel water entering a reactor core; and
providing a sufficient residence time to consume all but a tolerable amount of the added N₂H₄ prior to the vessel water entering a reactor core.

17. The method of claim 16, wherein the desired amount of H₂O₂ yields less than approximately 5 part per billion (mass) H₂O₂ in vessel water entering the reactor core.

18. The method of claim 16, further comprising the step of enhancing the reaction of N₂H₄ with H₂O₂ by using a catalyst.

19. The method of claim 18, wherein the catalyst comprises Cu2+ ions in the feed water.

20. A method for controlling vessel chemistry of a boiling water reactor (BWR), comprising the steps of:
adding a sufficient amount of N₂H₄ at an effective location to react with H₂O₂ and to reduce an initial amount of H₂O₂ to a desired amount in vessel water entering a reactor core;
providing a sufficient residence time to consume all but a tolerable amount of the added N₂H₄ prior to the vessel water entering a reactor core;
examining vessel water upstream of the reactor core to assess the type and amount of N₂H₄ fragments; and
calculating electrochemical corrosion potential from the type and amount of N₂H₄ fragments.

21. A method of controlling reaction vessel chemistry of a boiling water reactor (BWR) having a feed water flow stream entering a reaction vessel, the method comprising the steps of:
calculating an amount of N₂H₄ necessary to consume at least a majority of an amount of H₂O₂ in a fluid of the BWR;
injecting at least a portion of the calculated amount of N₂H₄ into the feed water flow stream; and
evaluate whether the injected N₂H₄ consumed the majority of the amount of H₂O₂ in a fluid of the BWR.

22. The method of claim 21, wherein the step of calculating the amount of N₂H₄ comprises the steps of:
determining an amount of H₂O₂ in the fluid of the BWR;
determining an amount of H₂O₂ to remain in the fluid of the BWR; and
calculating the amount of N₂H₄ necessary to consume all but the amount of H₂O₂ to remain in the fluid of the BWR.

23. The method of claim 22, wherein the step of determining the amount of H₂O₂ to remain comprises the steps of:
evaluating the ECP; and
reducing the determined amount of H₂O₂ to remain until the ECP is less than or equal to −230 mev.

24. The method of claim 21, wherein the step of calculating the amount of N₂H₄ comprises the step of calculating an amount of N₂H₄ necessary to consume both an amount of O₂ and the majority of the amount of H₂O₂.

25. The method of claim 21, wherein the step of calculating the amount of N₂H₄ comprises the steps of:
calculating a duration of time during which the amount of N₂H₄ will react with the H₂O₂; and
adjusting the calculated amount of N₂H₄ necessary in accordance with the duration of time.

26. The method of claim 21, wherein the step of injecting the portion of the calculated amount of N₂H₄ comprises the step of injecting N₂H₄ into the feedwater system.

27. The method of claim 21, wherein the step of injecting the portion of the calculated amount of N₂H₄ comprises the steps of:
repeatedly injecting the portion of the calculated amount of N₂H₄ into the feed water flow stream;
monitoring at least one of a main steam line radiation dose rate, an advanced offgas system offgas, a reactor water cleanup, and an ECP to evaluate the effectiveness of the N₂H₄ injection.

28. The method of claim 27, wherein repeatedly injecting the portion of the calculated amount of N₂H₄ comprises the step of periodically injecting approximately 10% of the calculated amount of N₂H₄ in increasing increments until 100% of the calculated amount of N₂H₄ is injected.

29. The method of claim 21, further comprising the steps of:
determining an amount of catalyst to enhance the consumption of the majority of the amount of H₂O₂;
adding the amount catalyst to the feed water flow stream; and
adjusting the calculated amount of N₂H₄ in accordance with the added catalyst.

30. The method of claim 29, wherein the catalyst is Cu⁺².
